(19) United States
(12) Patent Application Publication
(10) Pub. No.: US 2022/0389245 A1
(43) Pub. Date: Dec. 8, 2022

(54) METAL OXIDE NANOPARTICLES

(71) Applicant: BASF SE, Ludwigshafen am Rhein (DE)

(72) Inventors: Nikolay A. GRIGORENKO, Basel (CH); Michelle RICHERT, Basel (CH); Andre OSWALD, Schweizerhalle (Muttenz) (CH)

(21) Appl. No.: 17/760,782

(22) PCT Filed: Sep. 14, 2020
(86) PCT No.: PCT/EP2020/075640

§ 371 Date: Mar. 16, 2022

(30) Foreign Application Priority Data
Sep. 17, 2019 (EP) 19197706.5

(51) Int. Cl. C09D 11/037; C01G 23/053; C09C 1/36; C09C 3/08; C09D 11/101; C09D 11/107; B42D 25/373

(52) U.S. Cl. CPC C09D 11/037; C01G 23/0536; C09C 1/3669; C09C 3/08; C09D 11/101; C09D 11/107; B42D 25/373; C01P 2004/64; B82Y 40/00

(57) ABSTRACT

The present invention relates to metal oxide nanoparticles, a method for their production, a coating, or printing composition, comprising the metal oxide nanoparticles and the use of the composition for coating of surface relief micro- and nanostructures (e.g. holograms), manufacturing of optical waveguides, solar panels, light outcoupling layers for display and lighting devices and anti-reflection coatings. Holograms are bright and visible from any angle, when coated, or printed with the composition, comprising the metal oxide nanoparticles.

The present invention relates to metal oxide nanoparticles, a method for their production, a coating, or printing composition, comprising the metal oxide nanoparticles and the use of the composition for coating of surface relief micro- and nanostructures (e.g. holograms), manufacturing of optical waveguides, solar panels, light outcoupling layers for display and lighting devices and anti-reflection coatings. Holograms are bright and visible from any angle, when coated, or printed with the composition, comprising the metal oxide nanoparticles.

Mechanistic Aspects in the Formation, Growth and Surface Functionalization of Metal Oxide Nanoparticles in Organic Solvents are described by R. Deshmukh and M. Niederberger in Chem. Eur. J. 23 (2017) 8542-8570 and the literature cited therein:

Robert K. Y. Li et al., Dalton Trans. 42 (2013) 9777 describe a class of benzyl alcohol-based reactions for the synthesis of a series of inorganic oxide nanoparticles. Benzyl alcohol served as both the solvent and the reagent to interact with various metal chlorides for the synthesis of a series of metal oxides and compound oxides. Typical metal(IV) oxides, like TiO₂, metal(III) oxides, like Fe₂O₃, and metal(II) oxides, like ZnO, have been prepared through these reactions.

In Robert K. Y. Li et al., Nanoscale 4 (2012) 6284-6288 tert-amyl alcohol was employed to directly react with metal chlorides for the preparation of oxide nanoparticles. Some typical metal oxide or hydroxides with different morphologies, such as TiO₂ nanoparticles, TiO₂ nanorods, FeOOH nanowires, Fe₂O₃ nanoparticles, and SnO₂ nanoparticles, can be easily fabricated through simple chemical reactions.

Vitor. S. Amaral et al., RSC Adv., 2014, 4, 46762 report a novel method to synthesise spherical TiO₂ nanoparticles (NPs) in one pot. The reaction between titanium(IV) tert-butoxide (Ti[OC(CH₃)₃]₄) and benzyl alcohol resulted in the formation of highly crystalline titania NPs with a small size of only 6 nm, and with a correspondingly high surface area.

Hexing Li et al., CrystEngComm., 2010, 12, 2219 describes a process for synthesizing anatase TiO₂ nanocrystals with dominant {001} facets by solvothermal alcoholysis of TiF₄. Using tert-butanol as the initial alcohol source results in a total surface area of 103 m² g⁻¹ with small crystal sizes around 23 nm.

H. Weller et al. J. Amer. Chem. Soc. 125 (2003) 14539 describe the synthesis of high aspect ratio anastase TiO₂ nanorods by hydrolysis of titanium tetraisopropoxide in oleic acid at a temperature as low as 80° C. Typically the TiO₂ nanorods have uniform lengths up to 40 nm and a diameter of 3 to 4 nm.

B. Wang et al., Macromolecules 24 (1991) 3449 describe the preparation of high refractive index organic/inorganic hybrid materials from sol-gel processing.

R. Himmelhuber et al., Optical Materials Express 1 (2011) 252 describe titanium oxide sol gel films with tunable refractive index.

US2012276683 describes the preparation of titania pastes. Hydrochloric acid as a catalyst and distilled water as a dispersing medium are mixed at room temperature of about 20° C. to 25° C. at a molar ratio of hydrochloric acid to distilled water of 0.5:351.3. Next, one mole of titanium tetraisopropoxide as a titanium precursor is added to the solution under continuous stirring, forming a thick, white precipitate. Finally, the sol is peptized for about two hours to form a clear titania sol. The titania nanoparticles exhibit a narrow size distribution ranging from about 10 nm to about 27 nm with an average particle size of 19 nm. During experimentation, it was found that the titania sol was stable for at least seven months.

US2005164876 relates to the preparation of photocatalysts. 10 g of titanium isopropoxide (TTIP, Acros) was slowly added at room temperature to a solution of absolute ethanol (EtOH) in a breaker under vigorously stirred for 0.5 h to prevent a local concentration of the TTIP solution. EtOH mixed with nitric acid was added to the solution to promote hydrolysis. Polyethylene glycol (PEG, Acros) 600 was added to the solution and stirred for 1 h. The solution was then ultra sounded for 0.5 h and left for 24 h before being used. The molar ratio of TTIP:EtOH:PEG was 1:15:10, corresponding to 5 weight percent of TiO₂ in order to compare the photodegradation using P25. Photocatalyst T1 was immobilized on glass fiber by dip-coating. The glass fiber was loaded into the solution for 30 min and retracted at a rate of 10 mm/s. The glass fiber was dried at 100° C. for 2 h and then calcinated at 450° C. for 2 h at a heating rate of 5.5° C./min in air. The average crystallite size of T1 deposited on glass fiber was 9.8 nm.

Surface stabilized titanium dioxide nanoparticle are, for example, described in EP0707051, WO2006094915, US2011226321 and G. J. Ruitencamp et al. J. Nanopart. Res. 2011, 13, 2779.

For many optical applications, high refractive index materials are highly desirable. However, those materials consist of metal oxides e.g ZrO₂ (RI (Refractive Index) ca. 2.13) or TiO₂ (RI ca. 2.59) which are not easy to process in printing lacquers and are incompatible with merely organic carrier materials or organic overcoats. A number of methods for compatibilizing e.g. TiO₂-surfaces have been described (D. Geldof et al. Surface Science, 2017, 655, 31). However, carboxylate ligands or siloxane ligands—which always give high amounts of unwanted homocondensation by-products—although easily prepared are not stable toward hydrolysis. Highly stable surface coatings may be achieved with phosphonate ligands (WO 2006/094915). The Ti—O—P bonding is highly stable and forms the required colorless coats (R. Luschtinetz et al. J. Phys. Chem. C 2009, 113, 5730). The adsorption and chemical stable bonding also takes place rapidly. The stability of phosphonate ligands is based on the specific binding mode of the phosphonate (phosphate) moiety on TiO₂-surfaces. Potentially, three oxygen atoms can attach to the metal surface resulting in enhanced surface binding.

In addition, besides being cheap and non-toxic TiO₂ nanoparticles can be prepared in various core sizes. The preferred particle size however, should be <40 nm, in order to avoid the Rayleigh's scattering in the visible spectrum range (W. Casari et al. Chem. Eng. Commun. 2009, 196, 549) and thus forming a transparent material.

WO2019016136 relates to surface functionalized titanium dioxide nanoparticles, a method for their production, a coating composition, comprising the surface functionalized titanium dioxide nanoparticles and the use of the coating composition for coating holograms, wave guides and solar panels. Holograms are bright and visible from any angle, when printed with the coating composition, comprising the surface functionalized titanium dioxide nanoparticles.

One aspect of the present invention relates to the preparation of transparent, redissolvable storage stable metal oxide nanoparticles, in particular titanium dioxide nanoparticles via a so-called sol-gel process resulting in high refractive index material.

Accordingly, the present invention relates to a process for the preparation of single, or mixed metal oxide nanoparticles comprises the following steps:

a) preparing a mixture, comprising a metal oxide precursor compound(s), a solvent, a tertiary alcohol, or a secondary alcohol, wherein the tertiary alcohol and secondary alcohol eliminate water upon heating the mixture to a temperature of above 60° C., or mixtures, containing the tertiary alcohol(s) and/or the secondary alcohol(s), and optionally water,

b) heating the mixture to a temperature of above 60° C.,

c) treating the obtained nanoparticles with a base, especially a base which is selected from the group consisting of alkali metal alkoxides, alkali metal hydroxides, alkali metal salts of carboxylic acids, tetraalkylammonium hydroxides, trialkylbenzylammonium hydroxides and combinations thereof, wherein

the metal oxide precursor compound(s) is selected from the group consisting of metal alkoxides of formula Me(OR¹²)ₓ (I), metal halides of formula Me′(Hal)_{x′} (II) and metal alkoxyhalides of formula Me″(Hal′)ₘ(OR^{12′})ₙ (III) and mixtures thereof, wherein Me, Me′ and Me″ are independently of each other titanium, tin, tantalum, niobium, hafnium, or zirconium;

x represents the valence of the metal and is either 4 or 5,

x′ represents the valence of the metal and is either 4 or 5;

R¹² and R^{12′} are independently of each other a C₁-C₈alkyl group;

Hal and Hal′ are independently of each other Cl, Br or I;

m is an integer of 1 to 4;

n is an integer of 1 to 4;

m+n represents the valence of the metal and is either 4 or 5;

the solvent comprises at least one ether group and is different from the tertiary alcohol and the secondary alcohol;

the ratio of the sum of moles of hydroxy groups of tertiary alcohol(s) and secondary alcohol(s) to total moles of Me, Me′ and Me″ is in the range 1:2 to 6:1.

The above described process offers the following advantages over the prior art:
no use of autoclaves and high pressure;
simple isolation and purification of the product by filtration;
no toxic by-products, like benzyl chloride (important for printing application);
relatively low ratio Cl/Ti, which makes the neutralization easier; and
relatively low corrosivity of the product dispersion;
relatively low process temperature (60-180° C.).

In addition, the metal oxide nanoparticles dispersions after addition of the base have a pH value of higher than 3.5, are dispersible in organic solvents and are compatible with organic polymerizable monomers.

The tertiary alcohol is preferably a compound of formula

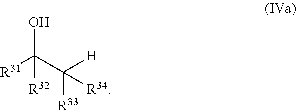

R³¹ and R³² are independently from each other a C₁-C₈alkyl group, a C₃-C₇cycloalkyl group, a C₂-C₈alkenyl group, a C₅-C₇cycloalkenyl group, or a C₂-C₈alkynyl group, optionally substituted with one, or more hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy groups; a C₇-C₁₄aralkyl group, optionally substituted with one, or more hydroxy, C₁-C₈alkyl, C₅-C₇cycloalkyl, C₂-C₈alkenyl, C₅-C₇cycloalkenyl, or C₁-C₈alkoxy groups, with the proviso that a hydroxy group is not attached to the aromatic ring. R³³ and R³⁴ are independently from each other H; a C₁-C₈alkyl group, a C₅-C₇cycloalkyl group, a C₂-C₈alkenyl group, a C₅-C₇cycloalkenyl group, or a C₂-C₈alkynyl group, optionally substituted with one, or more hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl group, hydroxyC₁-C₈alkyl, hydroxyC₅-C₇cycloalkyl, or C₁-C₈alkoxy groups; a C₇-C₁₄aralkyl group, optionally substituted with one, or more hydroxy, C₁-C₈alkyl, C₅-C₇cycloalkyl, C₂-C₈alkenyl, C₅-C₇cycloalkenyl, or C₁-C₈alkoxy groups. Alternatively, R³¹ and R³², or R³¹ and R³³, or R³³ and R³⁴ may form a 4 to 8 membered ring, optionally containing 1 or 2 carbon-carbon double bonds and/or 1 or 2 oxygen atoms. The 4 to 8 membered ring may further be substituted with one, or more C₁-C₈alkyl, C₅-C₇cycloalkyl, C₂-C₈alkenyl, C₅-C₈aryl, C₅-C₇cycloalkenyl, hydroxyC₁-C₈alkyl, hydroxyC₅-C₇cycloalkyl, or C₁-C₈alkoxy groups; a methylene group, optionally substituted with C₁-C₈alkyl, or C₅-C₇cycloalkyl groups.

The secondary alcohol is preferably a compound of formula

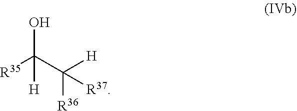

R³⁵ is a vinyl group, optionally substituted with one, or more C₁-C₈alkyl, C₅-C₇cycloalkyl, C₂-C₈alkenyl, C₅-C₇cycloalkenyl, or C₂-C₈alkynyl groups, optionally substituted with one, or more hydroxy, or C₁-C₈alkoxy groups.

an allyl group, optionally substituted with one, or more hydroxy, C₁-C₈alkyl, C₅-C₇cycloalkyl, C₂-C₈alkenyl, C₅-C₇cycloalkenyl, C₅-C₈aryl, or C₂-C₈alkynyl groups, which may further be substituted with hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy groups; a benzyl group optionally substituted with one, or more hydroxy, C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy groups; with the proviso that hydroxy group is not attached to the aromatic ring.

R³⁶ and R³⁷ are independently from each other H; C₁-C₈alkyl group, a C₅-C₇cycloalkyl group, an C₂-C₈alkenyl group, a C₅-C₇cycloalkenyl group, or an C₂-C₈alkynyl group, optionally substituted with one, or more hydroxy, or C₁-C₈alkoxy groups; a phenyl group, optionally substituted with one, or more C₁-C₈alkyl, C₅-C₇cycloalkyl, C₂-C₈alkenyl, C₅-C₇cycloalkenyl, hydroxyC₁-C₈alkyl, hydroxyC₅-C₇cycloalkyl, or C₁-C₈alkoxy; a C₇-C₁₄aralkyl group, optionally substituted with one, or more hydroxy, C₁-C₈alkyl, C₅-C₇cycloalkyl, C₂-C₈alkenyl, C₅-C₇cycloalkenyl, or C₁-C₈alkoxy groups, with the proviso that hydroxy group is not attached to the aromatic ring.

Alternatively, R³⁵ and R³⁶, or R³⁶ and R³⁷ may form a 4 to 8 membered ring, optionally containing 1 or 2 carbon-carbon double bonds and/or 1 or 2 oxygen atoms. The 4 to 8 membered ring may further be substituted with one, or more C₁-C₈alkyl, C₅-C₇cycloalkyl, C₂-C₈alkenyl, C₅-C₈aryl, C₅-C₇cycloalkenyl, hydroxyC₁-C₈alkyl, hydroxyC₅-C₇cycloalkyl, or C₁-C₈alkoxy groups; a methylene group, optionally substituted with C₁-C₈alkyl, or C₅-C₇cycloalkyl groups.

Neither of R³¹, R³², R³³, R³⁴, R³⁵, R³⁶ and R³⁷ contain vinyloxy

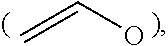

or ethynyloxy

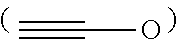

fragments.

The secondary alcohol is more preferably a compound of formula

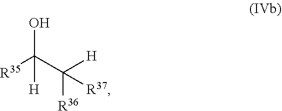

wherein R³⁵ is a vinyl group, optionally substituted with one, or more C₁-C₈alkyl groups; a phenyl group, optionally substituted with one, or more C₁-C₈alkyl, or C₁-C₈alkoxy groups; R³⁶ and R³⁷ are independently from each other H; C₁-C₈alkyl group, optionally substituted with one, or more hydroxy, or C₁-C₈alkoxy groups; a phenyl group, optionally substituted with one, or more C₁-C₈alkyl, or C₁-C₈alkoxy groups; or R³⁵ and R³⁶, or R³⁶ and R³⁷ may form a 5, or 6 membered ring, optionally containing a carbon-carbon double bond and/or optionally substituted with one, or more C₁-C₈alkyl groups.

The secondary alcohol of formula (IVb) used in step a) is even more preferably selected from the group consisting of 1-phenylethanol, 1-phenylpropanol, 1-phenyl-1-butanol, 1-butene-3-ol, 1-pentene-3-ol, 2-cyclohexen-1-ol, 3-methyl-2-cyclohexen-1-ol.

Tertiary alcohols of formula (IVa) are more preferred than secondary alcohols of formula (IVb).

The tertiary alcohol is more preferably a tertiary alcohol of formula (IVa), wherein R³¹ is a C₁-C₈alkyl group,

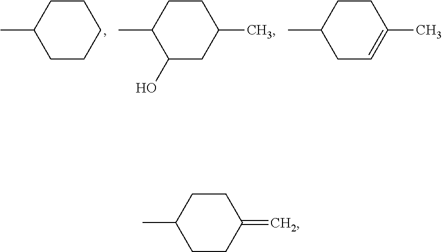

a benzyl group, a phenyl group, which is optionally substituted with one, or more C₁-C₄alkyl and/or C₁-C₄alkoxy groups; or a vinyl group, which is optionally substituted with one, or more C₁-C₈alkyl groups; R³², R³³ and R³⁴ are independently of each other a C₁-C₈alkyl group, which is optionally substituted by a hydroxy group, or a C₁-C₈alkenyl group, which is optionally substituted by a hydroxy group; or

R³¹ and R³² together with the carbon atom to which they are bonded form a 5, or 6 membered ring, optionally containing a carbon-carbon double bond and/or optionally substituted with one, or more C₁-C₈alkyl groups, or a methylene group, optionally substituted with one, or two C₁-C₈alkyl groups, especially R³¹ and R³² together with the carbon atom to which they are bonded form a ring

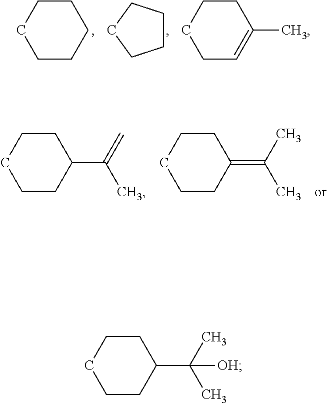

or R³³ and R³⁴ may form a 5, or 6 membered ring, optionally containing a carbon-carbon double bond and/or optionally substituted with one, or more C₁-C₈alkyl groups.

The tertiary alcohol used in step a) is preferably selected from the group consisting of tertbutanol, 2-methyl-2-butanol, 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 1-vinylcyclohexanol, 2-methyl-2,4-pentanediol, 2,4-dimethyl-2,4-pentanediol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 1-methoxy-2-methyl-2-propanol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), 3,7-dimethylocta-1,5-dien-3,7-diol (terpenediol I), terpinen-4-ol (4-carvomenthenol), (±)-3,7-dimethyl-1,6-octadien-3-ol (linalool) and mixtures thereof.

More preferred tertiary alcohols of formula (IV) are selected from tert-butanol, 2-methyl-2-butanol (tert-pentanol), 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), terpinen-4-ol (4-carvomenthenol).

The at present most preferred tertiary alcohols of formula (IVa) are 2-methyl-2-butanol and 2,5-dimethyl-2,5-hexanediol.

C₁-C₈alkyl is typically linear or branched, where possible. Examples are methyl, ethyl, n-propyl, isopropyl, n-butyl, sec.-butyl, isobutyl, tert-butyl, n-pentyl, 2-pentyl, 3-pentyl, 2,2-dimethyl-propyl, n-hexyl, n-heptyl, n-octyl, 1,1,3,3-tetramethylbutyl and 2-ethylhexyl. C₁-C₄alkyl is typically methyl, ethyl, n-propyl, isopropyl, n-butyl, sec.-butyl, isobutyl, tert-butyl.

Examples of linear or branched C₁-C₈alkoxy are methoxy, ethoxy, n-propoxy, isopropoxy, n-butoxy, sec.-butoxy, isobutoxy, tert.-butoxy, n-pentyloxy, 2-pentyloxy, 3-pentyloxy, 2,2-dimethylpropoxy, n-hexyloxy, n-heptyloxy, n-octyloxy, 1,1,3,3-tetramethylbutoxy and 2-ethylhexyloxy, preferably C₁-C₄alkoxy such as typically methoxy, ethoxy, n-propoxy, isopropoxy, n-butoxy, sec.-butoxy, isobutoxy, tert-butoxy.

Examples of C₂-C₈alkenyl groups are straight-chain or branched alkenyl groups, such as, for example, vinyl, allyl, methallyl, isopropenyl, 2-butenyl, 3-butenyl, isobutenyl, n-penta-2,4-dienyl, 3-methyl-but-2-enyl, n-oct-2-enyl.

C₂-C₈alkynyl is straight-chain or branched and is, for example, ethynyl, 1-propyn-3-yl, 1-butyn-4-yl, 1-pentyn-5-yl, 2-methyl-3-butyn-2-yl, 1,4-pentadiyn-3-yl, 1,3-pentadiyn-5-yl, 1-hexyn-6-yl, cis-3-methyl-2-penten-4-yn-1-yl, trans-3-methyl-2-penten-4-yn-1-yl, 1,3-hexadiyn-5-yl, 1-octyn-8-yl.

Examples of a C₅-C₇cycloalkyl group are cyclopentyl, cyclohexyl and cycloheptyl, optionally substituted with one, or more C₁-C₈alkyl groups, or a methylene group, optionally substituted with one, or two C₁-C₈alkyl groups.

The C₅-C₇cycloalkenyl is a C₅-C₇cycloalkyl group, containing one, or two carbon carbon double bonds.

The solvent used in step a) is preferably selected from the group consisting of tetrahydrofuran, 2-methyltetrahydrofurane, tetrahydropyrane, 1,4-dioxane, cyclopentylmethyl ether, diisopropyl ether, di-n-propyl ether, di-isobutyl ether, di-tert-butyl ether, di-n-butyl ether, di(3-methylbutyl) ether (diisoamyl ether), di-n-pentyl ether, di-n-hexyl ether, di-n-octyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene glycol) di-n-butyl ether, 1,2-dimethoxypropane, 1,2-diethoxypropane, 1,3-dimethoxypropane, 1,3-diethoxypropane, 1,4-dimethoxybutane, 1,4-diethoxybutane, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof.

More preferred, the solvent is selected from 2-methyltetrahydrofurane, tetrahydropyrane, 1,4-dioxane, cyclopentylmethyl ether, di-n-propyl ether, di-isobutyl ether, di-tert-butyl ether, di-n-butyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene glycol) di-n-butyl ether, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof.

The metal oxide precursor compound(s) is selected from the group consisting of metal alkoxides of formula Me(OR¹²)ₓ (I),

metal halides of formula Me′(Hal)_{x′} (II) and

metal alkoxyhalides of formula Me′(Hal′)ₘ(OR^{12′})ₙ (III) and mixtures thereof.

Me, Me′ and Me″ are independently of each other titanium, tin, tantalum, niobium, hafnium, or zirconium, especially titanium.

x represents the valence of the metal and is either 4 or 5.

x′ represents the valence of the metal and is either 4 or 5.

R¹² and R^{12′} are independently of each other a C₁-C₈alkyl group; especially a C₁-C₄alkyl group.

Hal and Hal′ are independently of each other Cl, Br or I; especially Cl.

m is an integer of 1 to 4.

n is an integer of 1 to 4.

m+n represents the valence of the metal and is either 4 or 5;

Preferably, the mixture used in step a) comprises a metal alkoxide of formula (I) and a metal halide of formula (II).

The metal alkoxide of formula (I) is preferably a metal alkoxide of formula Me(OR¹²)₄ (Ia), wherein R¹² is a C₁-C₄alkyl group. The metal halide of formula Me′(Hal)_{x′} (II) is preferably a metal halide of formula Me′(Hal)₄ (II), wherein Hal is Cl. Me and Me′ are preferably titanium.

The ratio of moles of hydroxy groups of tertiary alcohol to total moles of Ti is in the range 1:2 to 6:1, preferably 1:2 to 4:1, most preferably 1:2 to 3.5:1.

The temperature in step b) is preferably in the range 80 to 180° C.

The alcohol(s) R¹²OH and/or R^{12′}OH formed in step b) may be removed from the reaction mixture by distillation. The removal of the alcohol(s) R¹²OH and/or R^{12′}OH may increase the reaction rate and/or the product quality.

The base used in step c) is preferably selected from the group consisting of alkali metal alkoxides, alkali metal hydroxides, alkali metal salts of carboxylic acids, tetraalkylammonium hydroxides, trialkylbenzylammonium hydroxides and combinations thereof. More preferred, the base is selected from the group consisting of alkali metal alkoxides, especially potassium ethylate; alkali metal hydroxides, especially potassium hydroxide; alkali metal salts of carboxylic acids, especially potassium acrylate and methacrylate, and combinations thereof.

After treatment with base aliquots of nanoparticles dispersions in ethanol mixed with water (1:1 v/v) under vigorous stirring show a pH of greater than 3.5. That means, the obtained nanoparticles are have low corrosivity.

In a particularly preferred embodiment the process for the preparation of single, or mixed metal oxide nanoparticles comprises the following steps:

a) preparing a mixture, comprising a metal alkoxide of formula Ti(OR¹²)₄ (Ia), metal halide of formula Ti(Hal)₄ (IIa), wherein R¹² and R^{12′} are independently of each other C₁-C₄alkyl, preferably methyl, ethyl, n-propyl, iso-propyl and n-butyl;

Hal is Cl; a solvent, a tertiary alcohol and optionally water,

b) heating the mixture to a temperature of from 80° C. to 180° C.,

c) treating the obtained nanoparticles with a base, wherein

the ratio of moles of hydroxy groups of tertiary alcohol to total moles of Ti is in the range 1:2 to 6:1, preferably 1:2 to 4:1, most preferably 1:2 to 3.5:1;

the base is selected from the group consisting of alkali metal alkoxides, especially potassium ethylate; alkali metal hydroxides, especially potassium hydroxide; alkali metal salts of carboxylic acids, especially potassium acrylate and methacrylate, and combinations thereof,

the solvent is selected from 2-methyltetrahydrofurane, tetrahydropyrane, 1,4-dioxane, cyclopentylmethyl ether, di-n-propyl ether, di-isobutyl ether, di-tert-butyl ether, di-n-butyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene glycol) di-n-butyl ether, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof;

the tertiary alcohol is selected from tert-butanol, 2-methyl-2-butanol (tert-pentanol), 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), terpinen-4-ol (4-carvomenthenol), and wherein in step b) the alcohol R¹²OH is removed by distillation.

In another aspect the present invention relates to metal oxide nanoparticles, in particular titanium dioxide nanoparticles obtainable, or obtained by the above process.

The metal oxide, in particular titanium dioxide nanoparticles have a volume average particle size from 1 nm to 40 nm, preferably from 1 nm to 10 nm, more preferably from 1 nm to 7 nm. They can be resuspended, for example, in methanol, ethanol, propanol, 2-methoxy ethanol, iso-propanol, 2-iso-propoxy ethanol, 1-butanol, 1-methoxy-2-propanol. A film of the metal oxide, in particular titanium dioxide nanoparticles which is dried at 100° C. for 1 minute shows a refractive index of greater than 1.70 (589 nm), especially of greater than 1.80, very especially of greater than 1.90.

The process of the present invention results in metal oxide nanoparticles, especially titanium dioxide nanoparticles having a volume average particle size from 1 nm to 40 nm, preferably from 1 nm to 10 nm, more preferably from 1 nm to 5 nm; and a film of the metal oxide nanoparticles, especially titanium dioxide nanoparticles which is dried at 100° C. for 1 minute shows a refractive index of greater than 1.70 (589 nm), especially of greater than 1.80, very especially of greater than 1.90 and dispersions of the metal oxide nanoparticles, especially the titanium dioxide nanoparticles in ethanol mixed with water (1:1 v/v) under vigorous stirring show a pH of higher than 3.5 and lower than 10, preferably higher than 3.5 and lower than 7.

Dispersions of the metal oxide nanoparticles, especially the titanium dioxide nanoparticles in ethanol mixed with water (1:1 v/v) under vigorous stirring show a pH of higher than 3.5 and lower than 10, preferably higher than 3.5 and lower than 7.

The metal oxide nanoparticles, obtainable by the above process, may be bonded to alkoxide groups R¹²O—, R^{12′}O— and/or alkoxide groups derived from the teriary alcohols of formula (IVa) and secondary alcohols of formula (IVb) by abstraction of the proton from the corresponding hydroxy group(s).

In another aspect, the present invention relates to the surface functionalization of the metal oxide nanoparticles, in particular TiO₂ nanoparticles by both phosphonates and alkoxides. Preferably, either the alkoxides or preferably the phosphonates bear a polymerizable moiety, preferably an olefinic double bond polymerizable via photo initiation and/or radical initiation. The coating of the TiO₂ nanoparticles by phosphonates and alkoxides can be performed subsequently or stepwise in either order or simultaneously.

The process for the production of the surface functionalized titanium dioxide nanoparticles comprises the following steps:

(a) dispersing the titanium dioxide nanoparticles in a solvent, such as, for example, ethanol, or isopropanol,

(b) adding the phosphonate of formula (V) and optionally the alcohol of formula

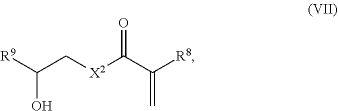

and

(c) stirring the mixture obtained in step (b) until a transparent dispersion is obtained.

Accordingly, the present invention relates to surface functionalized titanium dioxide nanoparticles coated with

a) a phosphonate of formula

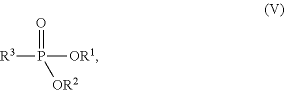

or a mixture of phosphonates of formula (V), wherein

R¹ and R² are independently of each other hydrogen, or a C₁-C₄alkyl group,

R³ is a group CH₂═CH—, or a group of formula —[CH₂]ₙ₂—R⁴, wherein n2 is an integer of 1 to 12,

when n>3 one —CH₂— may be replaced by —S— with the proviso that S is not directly linked to P, or R⁴,

R⁴ is hydrogen, or a group of formula

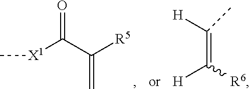

R⁵ is hydrogen, or a C₁-C₄alkyl group,

R⁶ is hydrogen, or a C₁-C₄alkyl group,

X¹ is O, or NH, and

b) bonded with an alkoxide of formula R⁷O⁻ (VI) and/or

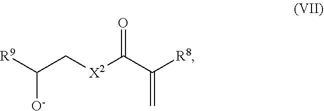

wherein

R⁷ is a C₁-C₈alkyl group, which may be interrupted one or more times by —O— and/or substituted one or more times by —OH,

R⁸ is hydrogen, or a C₁-C₄alkyl group,

R⁸ is hydrogen, —CH₂OH, —CH₂SPh, —CH₂OPh, or a group of formula R¹⁰—[CH₂OH—O—CH₂]ₙ₁—,

n1 is an integer of 1 to 5,

X² is O, or NH,

R¹⁸ is a group of formula —CH₂—X³—CH₂—C(═O)—CR¹¹═CH₂,

X³ is O, or NH, and

R¹¹ hydrogen, or a C₁-C₄alkyl group.

The surface functionalized titanium dioxide nanoparticles have a volume average size from 1 nm to 40 nm, preferably from 1 nm to 10 nm, more preferably from 1 nm to 7 nm.

The surface functionalized titanium dioxide nanoparticles exhibit a refractive index of greater than 1.70 (589 nm), especially of greater than 1.75, very especially of greater than 1.80, when coated on a glass plate and dried at 100° C.

The weight ratio of titanium dioxide nanoparticles to phosphonate(s) of formula (I) and alkoxide(s) of formula (VI) and (VI) is in the range of from 99:1 to 50:50, preferably 80:20 to 50:50, more preferably 70:30 to 50:50 and most preferably from 65:35 to 50:50.

The weight ratio of phosphonate(s) of formula (V) and alkoxide(s) of formula (VI) and (VII) is in the range of from 1:99 to 50:50, preferably 10:90 to 50:50, more preferably 5:95 to 50:50, and most preferably 3:97 to 50:50.

The phosphonate is preferably a phosphonate of formula (V), wherein

R¹ and R² are hydrogen,

R³ is a group CH₂═CH—, or a group of formula —[CH₂]ₙ₂—R⁴, wherein

n2 is an integer of 1 to 4,

R⁴ is hydrogen, or a group of formula

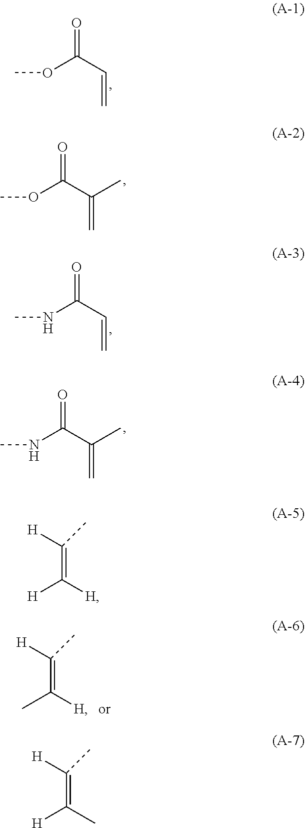

[symbol]

bond to [CH₂]ₙ).

Among the groups of formula (A-1) to (A-7) groups of formula (A-1) and (A-2) are preferred.

In one embodiment of the present invention phosphonates of formula

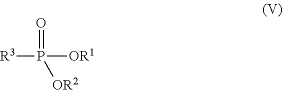

are more preferred, wherein

R¹ and R² are hydrogen,

R³ is a group of formula —[CH₂]ₙ₂—R⁴, wherein

n2 is an integer of 1 to 12,

R⁴ is hydrogen. This embodiment has the advantage of low refractive index dilution and rapid coating.

In another embodiment of the present invention phosphonates of formula

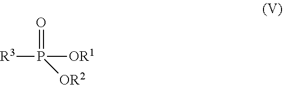

are more preferred, wherein

R¹ and R² are hydrogen,

R³ is a group of formula —[CH₂]ₙ₂—R⁴, wherein

n2 is an integer of 1 to 12,

when n>3 one —CH₂— may be replaced by —S— with the proviso that S is not directly linked to P, or R⁴,

R⁴ is a group of formula

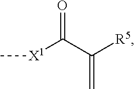

R⁵ is hydrogen, or a methyl group and X¹ is O, or NH, especially O. This embodiment offers the advantage of more stable attachment of olefinic groups to TiO₂ surface.

Examples of the phosphonate of formula (V) are

i) a compound of formula

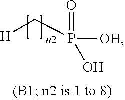

such as, for example,

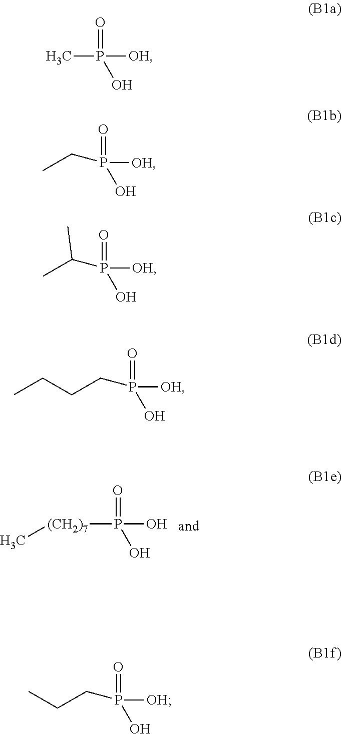

ii) a compound of formula

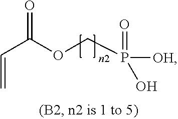

such as, for example,

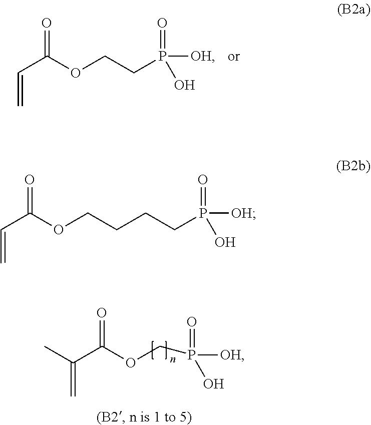

such as, for example,

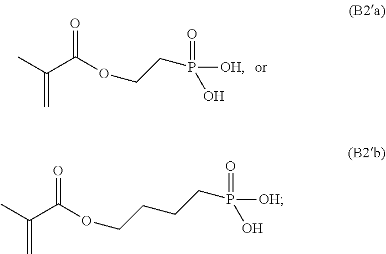

iii) a compound of formula

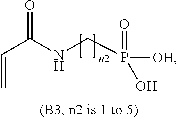

such as, for example,

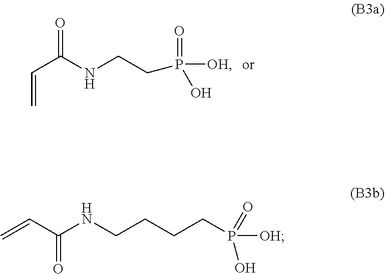

iv) a compound of formula

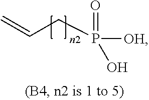

such as, for example,

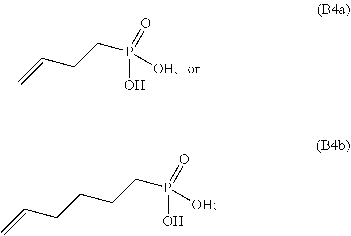

v) For n is 3 to 5 in compounds B2, B2′, B3 and B4 one —CH₂— may be replaced by sulfur resulting, for example, in a compound of formula

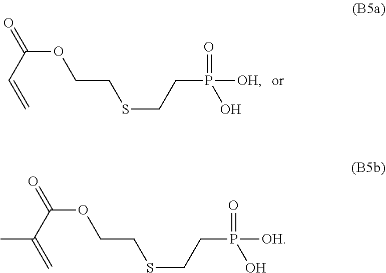

Compounds of formula (B3) are less preferred than compounds of formula (B2).

In the alkoxide of formula R⁷O⁻ (VI) R⁷ is a C₁-C₈alkyl group, which may be interrupted one or more times by —O— and/or substituted one or more times by —OH. Examples of the alkoxide of formula (VI) are CH₃O⁻(D-1), CH₃CH₂O⁻(D-2), CH₃CH₂CH₂O⁻(D-3), (CH₃)₂CHO⁻(D-4), CH₃CH₂CH₂CH₂O⁻(D-5), (CH₃)₂CHCH₂O⁻(D-6), (CH₃)₂CHOCH₂CH₂O⁻(D-7), (CH₃)₂CHOCHCH₂OH)(CH₂CH₂O⁻) (D-8), (CH₃)₂CHOCH₂CH(OH)(CH₂O⁻) (D-9). Preferred alkoxides of formula (VI) are CH₃CH₂O⁻ (D-2) and (CH₃)₂CHO⁻(D-4), because organic solvents used in the printing industries comprise preferably volatile primary and/or secondary alcohols.

The alkoxide of formula (VII) is preferably derived from the following alcohols:

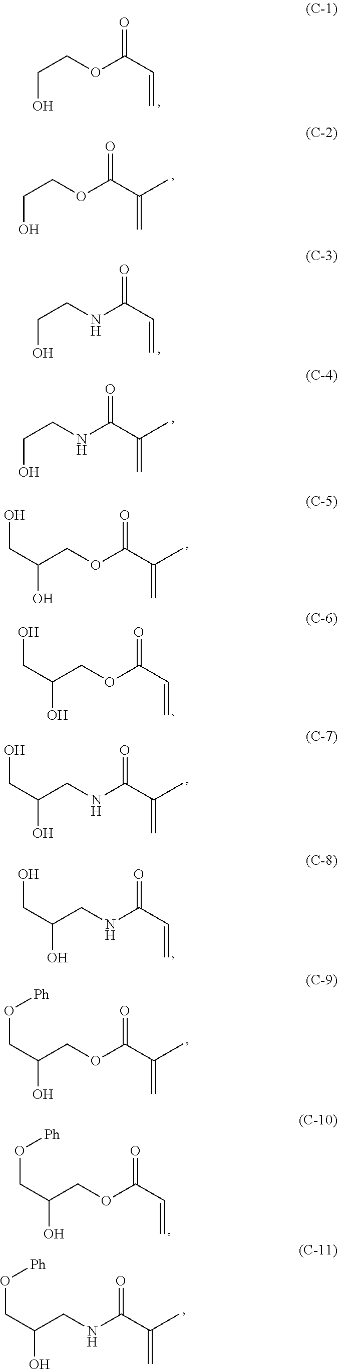

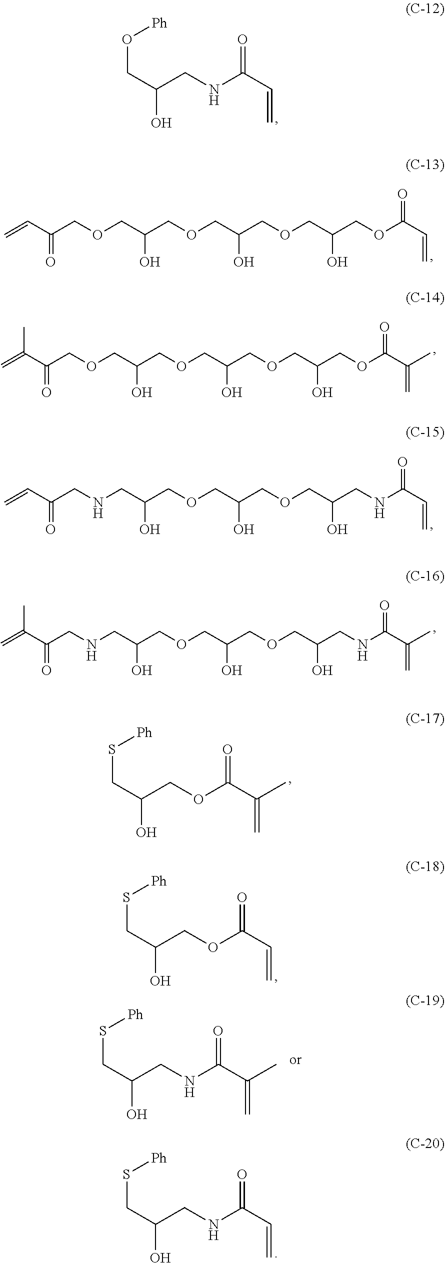

Among the alcohols of formula (C-1) to (C-20) alcohols of formula (C-9), (C-10), (C-13) and (C-14) are preferred.

A single phosphonate or a mixture of up to three different phosphonates, preferably two phosphonates with weight ratios of 1:99 to 99:1 may be used, according the specific application parameters.

Examples of surface functionalized TiO₂ particles are shown in the table below:

| Example | | |
|---|---|---|
| (TiO₂ nanop.) | Phosphonate (V) | Alkoxide (Vl)/(VII) |
| (T-1) | (B1a) | (D-2), (D-4) |
| (T-2) | (B1a) | (D-2), (D-4), (C-10′) |
| (T-3) | (B1a), (B3b) | (D-2), (D-4) |
| (T-4) | (B1a), (B2′a) | (D-2), (D-4) |
| (T-5) | (B1a), (B5b) | (D-2), (D-4) |
| (T-6) | (B1e), (B5b) | (D-2), (D-4) |
| (T-7) | (B2’a) | (D-2), (D-4), (C-10′) |
| (T-8) | (B1a) | (D-2) |
| (T-9) | (B1a) | (D-4) |

The (surface functionalized) TiO₂ nanoparticles having high refractive index and stability are soluble in organic solvents or aqueous mixtures of organic solvents used in the printing industries; those solvents preferably comprise volatile primary or secondary alcohols e.g as ethanol, iso-propanol and the like as known in the art.

The metal oxide nanoparticles of the present invention, or the surface functionalized metal oxide nanoparticles of the present invention may be used in light outcoupling layers for display and lighting devices, high dielectric constant (high-k) gate oxides and interlayer high-k dielectrics, anti-reflection coatings, etch and CMP stop layers, protection and sealing (OLED etc.), organic solar cells, optical thin film filters, optical diffractive gratings and hybrid thin film diffractive grating structures, or high refractive index abrasion-resistant coatings. y

Accordingly, the present invention is directed to a coating, or printing composition, comprising metal oxide nanoparticles, or the surface functionalized metal oxide nanoparticles, i.e. (surface functionalized) metal oxide nanoparticles of the present invention and optionally a solvent.

The solvent is preferably selected from alcohols (such as methanol, ethanol, 1-propanol, 2-propanol, 1-butanol, 2-butanol, isobutanol, tert-butanol, tert-pentanol), cyclic or acyclic ethers (such as diethyl ether, tetrahydrofuran and 2-methyltetrahydrofurane), ketones (such as acetone, 2-butanone, 3-pentanone, cyclopentanone and cyclohexanone), ether-alcohols (such as 2-methoxyethanol, 1-methoxy-2-propanol, ethylene glycol monobutyl ether, diethylene glycol monoethyl ether, diethylene glycol monopropyl ether, and diethylene glycol monobutyl ether), esters (such as ethyl acetate, ethyl propionate, and ethyl 3-ethoxypropionate), mixtures thereof and mixtures with water.

Volatile primary or secondary alcohols, like ethanol and iso-propanol, ether-alcohols, like 1-methoxy-2-propanol, ketones, like acetone, 2-butanone and cyclopentanone, and mixtures thereof are most preferred.

The amount of solvent in the (coating or printing ink) composition is dependent on the coating process, printing process etc. For gravure printing the solvent may be present in the printing ink composition in an amount of from 80 to 97% by weight of the printing ink composition, preferably 90 to 95% by weight.

The compositions, preferably printing ink compositions may comprise a binder. Generally, the binder is a high-molecular-weight organic compound conventionally used in coating compositions. High molecular weight organic materials usually have molecular weights of about from 10³ to 10⁸ g/mol or even more. They may be, for example, natural resins, drying oils, rubber or casein, or natural substances derived therefrom, such as chlorinated rubber, oil-modified alkyd resins, viscose, cellulose ethers or esters, such as ethylcellulose, cellulose acetate, cellulose propionate, cellulose acetobutyrate or nitrocellulose, but especially totally synthetic organic polymers (thermosetting plastics and thermoplastics), as are obtained by polymerisation, polycondensation or polyaddition. From the class of the polymerisation resins there may be mentioned, especially, polyolefins, such as polyethylene, polypropylene or polyisobutylene, and also substituted polyolefins, such as polymerisation products of vinyl chloride, vinyl acetate, styrene, acrylonitrile, acrylic acid esters, methacrylic acid esters or butadiene, and also copolymerisation products of the said monomers, such as especially ABS or EVA.

With respect to the binder resin, a thermoplastic resin may be used, examples of which include, polyethylene based polymers [polyethylene (PE), ethylene-vinyl acetate copolymer (EVA), vinyl chloride-vinyl acetate copolymer, vinyl alcohol-vinyl acetate copolymer, polypropylene (PP), vinyl based polymers [poly(vinyl chloride) (PVC), poly(vinyl butyral) (PVB), poly(vinyl alcohol) (PVA), poly(vinylidene chloride) (PVdC), poly(vinyl acetate) (PVAc), poly(vinyl formal) (PVF)], polystyrene based polymers [polystyrene (PS), styrene-acrylonitrile copolymer (AS), acrylonitrile-butadiene-styrene copolymer (ABS)], acrylic based polymers [poly(methyl methacrylate) (PMMA), MMA-styrene copolymer], polycarbonate (PC), celluloses [ethyl cellulose (EC), cellulose acetate (CA), propyl cellulose (CP), cellulose acetate butyrate (CAB), cellulose nitrate (CN), also known as nitrocellulose], fluorin based polymers [polychlorofluoroethylene (PCTFE), polytetrafluoroethylene (PTFE), tetrafluoroethylene-hexafluoroethylene copolymer (FEP), poly(vinylidene fluoride) (PVdF)], urethane based polymers (PU), nylons [type 6, type 66, type 610, type 11], polyesters (alkyl) [polyethylene terephthalate (PET), polybutylene terephthalate (PBT), polycyclohexane terephthalate (PCT)], novolac type phenolic resins, or the like. In addition, thermosetting resins such as resol type phenolic resin, a urea resin, a melamine resin, a polyurethane resin, an epoxy resin, an unsaturated polyester and the like, and natural resins such as protein, gum, shellac, copal, starch and rosin may also be used.

The binder preferably comprises nitrocellulose, ethyl cellulose, cellulose acetate, cellulose acetate propionate (CAP), cellulose acetate butyrate (CAB), hydroxyethyl cellulose (HEC), hydroxypropyl cellulose (HPC), alcohol soluble propionate (ASP), vinyl chloride, vinyl acetate copolymers, vinyl acetate, vinyl, acrylic, polyurethane, polyamide, rosin ester, hydrocarbon, aldehyde, ketone, urethane, polythyleneterephthalate, terpene phenol, polyolefin, silicone, cellulose, polyamide, polyester, rosin ester resins, shellac and mixtures thereof, most preferred are soluble cellulose derivatives such as hydroxylethyl cellulose, hydroxypropyl cellulose, nitrocellulose, carboxymethylcellulose as well as chitosan and agarose, in particular hydroxyethyl cellulose and hydroxypropyl cellulose.

The (coating or printing ink) compositions may also comprise an additional colorant. Examples for suitable dyes and pigments are given subsequently.

The (printing ink or coating) composition may also contain a surfactant. In general surfactants change the surface tension of the composition. Typical surfactants are known to the skilled person, they are for example, anionic or non-ionic surfactants. Examples of anionic surfactants can be, for example, a sulfate, sulfonate or carboxylate surfactant or a mixture thereof. Preference is given to alkylbenzenesulfonates, alkyl sulfates, alkyl ether sulfates, olefin sulfonates, fatty acid salts, alkyl and alkenyl ether carboxylates or to an α-sulfonic fatty acid salt or an ester thereof.

Preferred sulfonates are, for example, alkylbenzenesulfonates having from 10 to 20 carbon atoms in the alkyl radical, alkyl sulfates having from 8 to 18 carbon atoms in the alkyl radical, alkyl ether sulfates having from 8 to 18 carbon atoms in the alkyl radical, and fatty acid salts derived from palm oil or tallow and having from 8 to 18 carbon atoms in the alkyl moiety. The average molar number of ethylene oxide units added to the alkyl ether sulfates is from 1 to 20, preferably from 1 to 10. The cation in the anionic surfactants is preferably an alkaline metal cation, especially sodium or potassium, more especially sodium. Preferred carboxylates are alkali metal sarcosinates of formula R₉—CON(R₁₀)CH₂COOM₁ wherein R₉ is C₉-C₁₇alkyl or C₉-C₁₇alkenyl, R₁₀ is C₁-C₄alkyl and M₁ is an alkali metal such as lithium, sodium, potassium, especially sodium.

C₉-C₁₇alkyl means n-, i-nonyl, n-, i-decyl, n-, i-undecyl, n-, i-dodecyl, n-, i-tridecyl, n-, tetradecyl, n-, i-pentadecyl, n-, i-hexadecyl, n-, i-heptadecyl.

C₉-C₁₇alkenyl means n-, i-nonenyl, n-, i-decenyl, n-, i-undecenyl, n-, i-dodecenyl, n-, tridecenyl, n-, i-tetradecenyl, n-, i-pentadecenyl, n-, i-hexadecenyl, n-, i-heptadecenyl.

The non-ionic surfactants may be, for example, a primary or secondary alcohol ethoxylate, especially a C₈-C₂₀aliphatic alcohol ethoxylated with an average of from 1 to 20 mol of ethylene oxide per alcohol group. Preference is given to primary and secondary C₁₀-C₁₅ aliphatic alcohols ethoxylated with an average of from 1 to 10 mol of ethylene oxide per alcohol group. Non-ethoxylated non-ionic surfactants, for example alkylpolyglycosides, glycerol monoethers and polyhydroxyamides (glucamide), may likewise be used.

The composition may further comprise a thickener (rheology modifier), a defoamer and/or levelling agent.

Furthermore, a plasticizer for stabilizing the flexibility and strength of the print film may be added according to the needs therefor.

The (coating, or printing ink) composition may further contain a dispersant. The dispersant may be any polymer which prevents agglomeration or aggregation of the spherical and shaped particles formed after heating step D). The dispersant may be a non-ionic, anionic or cationic polymer having a weight average molecular weight of from 500 to 2,000,000 g/mol, preferably from 1,500,000 to 1,000,000 g/mol, which forms a solution or emulsion in the aqueous mixture. Typically, the polymers may contain polar groups. Suitable polymeric dispersants often possess a two-component structure comprising a polymeric chain and an anchoring group. The particular combination of these leads to their effectiveness.

Suitable commercially available polymeric dispersants are, for example, EFKA® 4047, 4060, 4300, 4330, 4580, 4585, 4609, 4610, 4611, 8512, Disperbyk® 161, 162, 163, 164, 165, 166, 168, 169, 170, 2000, 2001, 2050, 2090, 2091, 2095, 2096, 2105, 2150, Ajinomoto Fine Techno's PB® 711, 821, 822, 823, 824, 827, Lubrizol's Solsperse® 24000, 31845, 32500, 32550, 32600, 33500, 34750, 36000, 36600, 37500, 39000, 41090, 44000, 53095, ALBRITECT® CP30 (a copolymer of acrylic acid and acrylphosphonate) and combinations thereof.

Preference is given to polymers having a phosphoric acid ester or phosphonate functionality. The polymeric dispersants may be used alone or in admixture of two or more.

The present invention is also directed to a coating, or printing composition, comprising the metal oxide nanoparticles of the present invention, or the surface functionalized metal oxide nanoparticles of the present invention.

In a preferred embodiment the present invention is directed to a coating, or printing composition, comprising the metal oxide nanoparticles of the present invention, or the surface functionalized metal oxide nanoparticles of the present invention, at least one polymerizable ethylenically unsaturated monomer, a photoinitiator and optionally a solvent.

In another preferred embodiment the present invention is directed to a coating, or printing composition, comprising the metal oxide nanoparticles of the present invention, or the surface functionalized metal oxide nanoparticles of the present invention, at least one epoxy compound, optionally a photoinitiator and optionally a solvent.

In another preferred embodiment the present invention is directed to a coating, or printing composition, comprising the metal oxide nanoparticles of the present invention, or the surface functionalized metal oxide nanoparticles of the present invention and a solvent. In said embodiment it is preferred that the coating, or printing composition does not comprise a (organic) binder, or photoinitiator.

Advantageously, the polymerizable ethylenically unsaturated monomers in a coating composition, comprising metal oxide nanoparticles according to the present invention, may have a refractive index (at 589 nm wavelength) higher than 1.50, especially higher than 1.55. Generally, such compounds may include bromine, iodine, sulfur, or phosphorus atoms, or aromatic rings. Examples of such monomers are benzyl acrylate, benzyl methacrylate, N-benzylmethacrylamide, phenoxyethyl acrylate (Laromer POEA), 2,4,6-tribromophenyl acrylate, pentabromophenyl acrylate, pentabromophenyl methacrylate, N-vinylphthalimide, bisphenol-A diacrylate, or methacrylate, ethoxylated bisphenol-A diacrylates, or bis(4-methacryloylthiophenyl) sulfide (CAS: 129283-82-5).

Preference is given to photoinitiators, which can be activated by irradiation with UV-A light

The coating composition of the present invention may be used for coating of surface relief micro- and nanostructures, manufacturing of optical waveguides, light outcoupling layers for display and lighting devices, anti-reflection coatings and solar panels.

The expression “surface relief” is used to refer to a non-planar part of the surface of a substrate, or layer, and typically defines a plurality of elevations and depressions. In particularly advantageous embodiments, the surface relief structure is a diffractive surface relief structure. The diffractive surface relief structure may be a diffraction grating (such as a square grating, sinusoidal grating, sawtooth grating or blazed grating), a hologram surface relief or another diffractive device that exhibits different appearances, e.g. diffractive colours and holographic replays (such as, for example, a lens, or microprism), at different viewing angles. For the purposes of this specification, such surface relief structures will be referred to as diffractive optically variable image devices (DOVIDs).

In embodiments, the high refractive index (HRI) layer obtained from the coating, or printing ink composition of the present invention may further comprise a dispersion of scattering particles having a dimension along at least one axis such that the HRI layer exhibits a first colour when viewed in reflection and a second, different colour when viewed in transmission.

Other examples of refractive structures that may be formed by the HRI layer include corner cubes and pyramidal structures. Such refractive structures are typically provided as an array. The pitch of such an array (e.g. the width of a microprism) is preferably in the range of 1-100 μm, more preferably 5-70 μm, and the height of the surface structure (e.g. the height of a microprism) is preferably in the range of 1-100 μm, more preferably 5-40 μm.

The coating, or printing ink composition of the present invention can be used in the manufacture of surface relief micro- and nanostructures, such as, for example, optically variable devices (OVD), such as, for example, a hologram.

The method for forming a surface relief micro- and/or nanostructure on a substrate comprising the steps of:
a) forming a surface relief micro- and/or nanostructure on a discrete portion of the substrate; and
b) depositing the coating composition according to the present invention on at least a portion of the surface relief micro- and/or nanostructure.

Depending on the components of the coating composition the process may comprise the steps of
c) removing the solvent; and
d) curing the dry coating by exposing it to actinic radiation, especially UV-light.

A further specific embodiment of the invention concerns a preferred method for forming a surface relief micro- and/or nanostructure on a substrate, wherein step a) comprises
a1) applying a curable compound to at least a portion of the substrate;
a2) contacting at least a portion of the curable compound with surface relief micro- and/or nanostructure forming means; and
a3) curing the curable compound.

Alternatively, the method for forming a surface relief micro- and/or nanostructure on a substrate comprises the steps of

a′) providing a sheet of base material, said sheet having an upper and lower surface;

b′) depositing the coating composition according to the present invention on at least a portion of the upper surface; and

c′) optionally removing a solvent;

d′) forming a surface relief micro- and/or nanostructure on at least a portion of the coating composition, and

e′) curing the coating composition by exposing it to actinic radiation, especially UV-light.

The forming of the surface relief micro- and/or nanostructure may be such that said micro- and/or nanostructure is formed also in the base material.

Yet a further specific embodiment of the invention concerns a preferred method for forming a surface relief micro- and/or nanostructure on a substrate, comprising the steps of

a″) providing a sheet of base material, said sheet having an upper and lower surface;

b″) depositing the coating composition according to the present invention on at least a portion of the upper surface; and

c″) optionally removing a solvent;

d″) curing the dry coating by exposing it to actinic radiation, especially UV-light; and

e″) forming a surface relief micro- and/or nanostructure on at least a portion of the coating composition.

The forming of the surface relief micro- and/or nanostructure may be such that said micro- and/or nanostructure is formed also in the base material.

The composition of the present invention may be applied to the substrate by means of conventional printing press such as gravure, ink-jet, flexographic, lithographic, offset, letterpress intaglio and/or screen process, or other printing process.

In another embodiment the composition may be applied by coating techniques, such as spraying, dipping, casting, slot-die coating, or spin-coating.

Preferably the printing process is carried out by flexographic, offset, screen, ink-jet, or by gravure printing.

The resulting coatings, comprising the (surface functionalized) TiO₂ nanoparticles, are transparent in the visible region. The transparent (surface functionalized) TiO₂ nanoparticles containing layer has a thickness from 30 nm to 20 μm after drying. The (surface functionalized) TiO₂ nanoparticles containing coating is preferably dried at below 120° C. to avoid damage of organic substrates and/or coating layers.

In another aspect the invention relates to the use of the (surface functionalized) TiO₂ nanoparticles in UV-curable printable curing inks preferably processed via gravure printing resulting in flexible hybrid (inorganic-organic) layers.

The resulting products may be coated with a protective coating. The protective coating is preferably transparent or translucent. Examples for such coatings are known to the skilled person. For example, water borne coatings, UV-cured coatings or laminated coatings may be used. Examples for typical coating resins will be given below.

The (surface functionalized) TiO₂ nanoparticles may be coated onto organic foils via gravure printing followed by a transparent overcoat subsequently being UV-cured (e.g. Lumogen OVD Primer 301®). That way ligands, i.e. phosphonates (V) and/or alkoxides (VI)/(VII), carrying olefinic moieties are arrested in the coating impeding subsequent migration and aggregation of the particles which would result in significant loss of transparency.

The (security, or decorative) product obtainable by using the above method forms a further subject of the present invention.

Accordingly, the present invention is directed to a security, or decorative element, comprising a substrate, which may contain indicia or other visible features in or on its surface, and on at least part of the said substrate surface, a coating containing the (surface functionalized) TiO₂ nanoparticles.

The resulting products may be overcoated with a protective coating to increase the durability and/or prevent copying of the security element. The protective coating is preferably transparent or translucent. The protective coating may have refractive index of from about 1.2 to about 1.75. Examples of such coatings are known to the skilled person. For example, water borne coatings, UV-cured coatings or laminated coatings may be used. Examples for typical coating resins will be given below. Coatings having a very low re-fractive index are, for example, described in U.S. Pat. No. 7,821,691, WO2008011919 and WO2013117334.

The composition may be coated onto organic foils via gravure printing followed by a transparent overcoat subsequently being UV-cured (e.g. Lumogen OVD Primer 301®).

The high refractive index coating according to the present invention may represent the dielectric layer in a so-called Fabry Perot Element. Reference is made, for example, to WO0153113. The high refractive index coating according to the present invention may be used in the fabrication of thin-film multilayer antireflective or reflective elements and coatings, comprising stacks of layers with different refractive indices. Reference is made, for example, to H. A. Macleod, “Thin-Film Optical Filters”, published by Institute of Phys-ics Publishing, 3rd edition, 2001; EP2806293A2 and DE102010009999A1.

Security devices of the sort described above can be incorporated into or applied to any article for which an authenticity check is desirable. In particular, such devices may be applied to or incorporated into documents of value such as banknotes, passports, driving licenses, cheques, identification cards etc. The security device or article can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travelers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0880298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices. The security device or article may be subsequently incorporated into a paper or polymer base substrate so that it is viewable from both sides of the finished security substrate. Methods of incorporating security elements in such a manner are described in EP-A-1 141480 and WO-A-03054297. In the method described in EP-A-1 141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-72350, EP-A-724519, WO-A-03054297 and EP-A-1398174.

The security device may also be applied to one side of a paper substrate so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

Typically the security product includes banknotes, credit cards, identification documents like passports, identification cards, driver licenses, or other verification documents, pharmaceutical apparel, software, compact discs, tobacco packaging and other products or packaging prone to counterfeiting or forgery.

The substrate may comprise any sheet material. The substrate may be opaque, substantially transparent or translucent, wherein the method described in WO08/061930 is especially suited for substrates, which are opaque to UV light (non-transparent). The substrate may comprise paper, leather, fabric such as silk, cotton, tyvac, filmic material or metal, such as aluminium. The substrate may be in the form of one or more sheets or a web. The substrate may be mould made, woven, non-woven, cast, calendared, blown, extruded and/or biaxially extruded. The substrate may comprise paper, fabric, man made fibres and polymeric compounds. The substrate may comprise any one or more selected from the group comprising paper, papers made from wood pulp or cotton or synthetic wood free fibres and board. The paper/board may be coated, calendared or machine glazed; coated, uncoated, mould made with cotton or denim content, Tyvac, linen, cotton, silk, leather, polythyleneterephthalate, polypropylene propafilm, polyvinylchloride, rigid PVC, cellulose, triacetate, acetate polystyrene, polyethylene, nylon, acrylic and polytherimide board. The polythyleneterephthalate substrate may be Melinex type film orientated polypropylene (obtainable from DuPont Films Wilmington Del. product ID Melinex HS-2).

The substrates being transparent films or non-transparent substrates like opaque plastic, paper including but not limited to banknote, voucher, passport, and any other security or fiduciary documents, self adhesive stamp and excise seals, card, tobacco, pharmaceutical, computer software packaging and certificates of authentication, aluminium, and the like.

In a preferred embodiment of the present invention the substrate is a non-transparent (opaque) sheet material, such as, for example, paper. Advantageously, the paper may be precoated with an UV curable lacquer. Suitable UV curable lacquers and coating methods are described, for example, WO2015/049262 and WO2016/156286.

In another preferred embodiment of the present invention the substrate is a transparent or translucent sheet material, such as, for example, polyethylene terephthalate, polyethylene naphthalate, polyvinyl butyral, polyvinyl chloride, flexible polyvinyl chloride, polymethyl methacrylate, poly(ethylene-co-vinyl acetate), polycarbonate, cellulose triacetate, polyether sulfone, polyester, polyamide, polyolefins, such as, for example, polypropylene, and acrylic resins. Among these, polyethylene terephthalate and polypropylene are preferred. The flexible substrate is preferably biaxially oriented.

The forming of an optically variable image on the substrate may comprise depositing a curable composition on at least a portion of the substrate, as described above. The curable composition, generally a coating or lacquer may be deposited by means of gravure, flexographic, ink jet and screen process printing. The curable lacquer may be cured by actinic radiations, preferably ultraviolet (UV) light or electron beam. Preferably, the curable lacquer is UV cured. UV curable lacquers are well known and can be obtained from e.g. BASF SE. The lacquers exposed to actinic radiations or electron beam used in the present invention are required to reach a solidified stage when they separate again from the imaging shim in order to keep the record in their upper layer of the sub-microscopic, holographic diffraction grating image or pattern (optically variable image, OVI). Particularly suitable for the lacquer compositions are mixtures of typical well-known components (such as photoinitiators, monomers, oligomers. levelling agents etc.) used in the radiation curable industrial coatings and graphic arts. Particularly suitable are compositions containing one or several photo-latent catalysts that will initiate polymerization of the lacquer layer exposed to actinic radiations. Particularly suitable for fast curing and conversion to a solid state are compositions comprising one or several monomers and oligomers sensitive to free-radical polymerization, such as acrylates, methacrylates or monomers or/and oligomers, containing at least one ethylenically unsaturated group, examples have already been given above. Further reference is made to pages 8 to 35 of WO2008/061930.

The UV lacquer may comprise an epoxy monomer from the CRAYNOR® Sartomer Europe range (10 to 60%) and one or several acrylates (monofunctional and multifunctional), monomers which are available from Sartomer Europe (20 to 90%) and one, or several photoinitiators (1 to 15%) such as Darocure® 1173 and a levelling agent such as BYK®361 (0.01 to 1%) from BYK Chemie.

The epoxy monomer is selected from aromatic glycidyl ethers aliphatic glycidyl ethers. Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy) phenyl]methane isomers (CAS No. [66072-39-7]), phenol-based epoxy novolaks (CAS No. [9003-35-4]), and cresol-based epoxy novolaks (CAS No. [37382-79-9]). Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

The one or several acrylates are preferably multifunctional monomers which are selected from trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, tripropylene glycol diacrylate (TPGDA), dipropylene glycol diacrylate (DPGDA), pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol, such as, for example, ethoxylated trimethylol propane triacrylate (TMEOPTA) and or mixtures thereof.

The photoinitiator may be a single compound, or a mixture of compounds. Examples of photoinitiators are known to the person skilled in the art and for example published by Kurt Dietliker in “A compilation of photoinitiators commercially available for UV today”, Sita Technology Textbook, Edinburgh, London, 2002.

The photoinitiator may be selected from acylphosphine oxide compounds, benzophenone compounds, alpha-hydroxy ketone compounds, alpha-alkoxyketone compounds, alpha-aminoketone compounds, phenylglyoxylate compounds, oxime ester compounds, mixtures thereof and mixtures and mixtures thereof.

The photoinitiator is preferably a blend of an alpha-hydroxy ketone, alpha-alkoxyketone or alpha-aminoketone compound and a benzophenone compound; or a blend of an alpha-hydroxy ketone, alpha-alkoxyketone or alpha-aminoketone compound, a benzophenone compound and an acylphosphine oxide compound.

The curable composition is preferably deposited by means of gravure or flexographic printing. The curable composition can be coloured.

An OVD is cast into the surface of the curable composition with a shim having the OVD thereon, the holographic image is imparted into the lacquer and instantly cured via a UV lamp, becoming a facsimile of the OVD disposed on the shim (U.S. Pat. Nos. 4,913,858, 5,164,227, WO2005/051675 and WO2008/061930).

The curable coating composition may be applied to the substrate by means of conventional printing press such as gravure, rotogravure, flexographic, lithographic, offset, letterpress intaglio and/or screen process, or other printing process.

Preferably the TiO₂ layer which is printed over the OVD is also sufficiently thin as to allow viewing in transmission and reflectance. In other words the whole security element on the substrate allows a viewing in transmission and reflectance.

In another preferred embodiment the security element comprises a multilayer structure capable of interference, wherein the multilayer structure capable of interference has a reflection layer, a dielectric layer, and a partially transparent layer (EP1504923, WO01/03945, WO01/53113, WO05/38136, WO16173696), wherein the dielectric layer is arranged between the reflection layer and the partially transparent layer.

Suitable materials for the reflective layer include aluminum, silver, copper mixtures or alloys thereof. Suitable materials for the dielectric layer include silicium dioxide, zinc sulfide, zinc oxide, zirconium oxide, zirconium dioxide, titanium dioxide, diamond-like carbon, indium oxide, indium-tin-oxide, tantalum pentoxide, cerium oxide, yttrium oxide, europium oxide, iron oxides, hafnium nitride, hafnium carbide, hafnium oxide, lanthanum oxide, magnesium oxide, magnesium fluoride, neodymium oxide, praseodymium oxide, samarium oxide, antimony trioxide, silicon monoxide, selenium trioxide, tin oxide, tungsten trioxide and combinations thereof as well as organic polymer acrylates.

The reflective layer is preferably an aluminum or silver layer and the dielectric layer is preferably formed from the (surface functionalized) TiO₂ nanoparticles of the present invention.

The curable composition may further comprise modifying additives, for example colorants and/or suitable solvent(s).

Specific additives can be added to the curable composition to modify its chemicals and/or physical properties. Polychromatic effects can be achieved by the introduction of (colored) inorganic and/or organic pigments and/or solvent soluble dyestuffs into the ink, to achieve a range of coloured shades. By addition of a dye the transmission colour can be influenced. By the addition of fluorescent or phosphorescent materials the transmission and/or the reflection colour can be influenced.

Suitable colored pigments especially include organic pigments selected from the group consisting of azo, azomethine, methine, anthraquinone, phthalocyanine, perinone, perylene, diketopyrrolopyrrole, thioindigo, dioxazine iminoisoindoline, dioxazine, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Colored organic pigments of particular interest include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, the 2,9-dichloro-quinacridone in platelet form described in WO08/055807, or a mixture or solid solution thereof.

Plateletlike organic pigments, such as plateletlike quinacridones, phthalocyanine, fluororubine, dioxazines, red perylenes or diketopyrrolopyrroles can advantageously be used.

Suitable colored pigments also include conventional inorganic pigments; especially those selected from the group consisting of metal oxides, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate, Prussian blue, Fe₃O₄, carbon black and mixed metal oxides.

Examples of dyes, which can be used to color the curable composition, are selected from the group consisting of azo, azomethine, methine, anthraquinone, phthalocyanine, dioxazine, flavanthrone, indanthrone, anthrapyrimidine and metal complex dyes. Monoazo dyes, cobalt complex dyes, chrome complex dyes, anthraquinone dyes and copper phthalocyanine dyes are preferred.

The surface relief micro- and nanostructures are, for example, microlense arrays, micromirror arrays, optically variable devices (OVDs), which are, for example, diffractive optical variable image s (DOVIs). The term “diffractive optical variable image” as used herein may refer to any type of holograms including, for example, but not limited to a multiple plane hologram (e.g., 2-dimensional hologram, 3-dimensional hologram, etc.), a stereogram, and a grating image (e.g., dot-matrix, pixelgram, exelgram, kinegram, etc.).

Examples of an optically variable device are holograms or diffraction gratings, moire grating, lenses etc. These optical micro- and nanostructured devices (or images) are composed of a series of structured surfaces. These surfaces may have straight or curved profiles, with constant or random spacing, and may even vary from microns to millimetres in dimension. Patterns may be circular, linear, or have no uniform pattern. For example a Fresnel lens has a micro- and nanostructured surface on one side and a plane surface on the other. The micro- and nanostructured surface consists of a series of grooves with changing slope angles as the distance from the optical axis increases. The draft facets located between the slope facets usually do not affect the optical performance of the Fresnel lens.

The compositions, comprising (surface modified) metal oxide nanoparticles of the present invention, may be applied on top of the surface relief micro- and nanostructures in transparent windows, security threads and foils on the document of value, right, identity, security label or branded good.

A further aspect of the present invention is the use of the element as described above for the prevention of counterfeit or reproduction, on a document of value, right, identity, a security label or a branded good.

The metal oxide nanoparticles of the present invention may be used in a method of manufacturing a security device described in EP2951023A1 comprising:

(a) providing a transparent substrate,

(b) applying a curable transparent material to a region of the substrate;

(c) in a first curing step, partially curing the curable transparent material by exposure to curing energy;

(d) applying a layer of the metal oxide nanoparticles of the present invention (reflection enhancing material) to the curable transparent material;

(e) forming the partially cured transparent material and the layer of the metal oxide nanoparticles of the present invention such that both surfaces of the layer of the metal oxide nanoparticles of the present invention follow the contours of an optically variable effect generating relief structure,

(f) in a second curing step, fully curing the formed transparent material by exposure to curing energy such that the relief structure is retained by the formed transparent material.

Furthermore, the metal oxide nanoparticles of the present invention may be used in a method of manufacturing of a shaped article, such as optical lens, or fiber, comprising the steps of

a) providing a base vinyl unsaturated monomer and/or polymeric composition,

b) dispersing the metal oxide nanoparticles of the present invention in the base composition to obtain a composite material,

c) using the obtained composite material to manufacture a shaped article by casting, molding, extrusion, spinning or combinations of these methods.

Various aspects and features of the present invention will be further discussed in terms of the examples. The following examples are intended to illustrate various aspects and features of the present invention.

### EXAMPLES

### Measurement of pH of Dispersions in Ethanol

The aliquots of nanoparticles dispersions in ethanol were mixed with water (1:1 v/v) under vigorous stirring and pH was measured in the resulting mixture by means of pH meter.

### Measurement of Refractive Indices of the Coatings by Ellipsometry

The nanoparticles-containing dispersions were coated onto silicon wafers to obtain coatings with thicknesses of at least 200 nm (thickness was measured with KLA Tencor Alpha-Step D-100 Stylus Profiler). The data was acquired in Reflectance mode at 65°, 70° and 75° angles, using Woollam M-2000-R19 ellipsometer, and the obtained data was fitted using the Cauchy model with WVase32 software.

### Measurement of Particle Size Distribution by DLS

The measurements were performed using Malvern Zetasizer Nano ZS device with ca. 3% w/w dispersions of nanoparticles in a suitable solvent. Measurements in ethanol were performed in presence of acrylic acid (15% w/w of acrylic acid relative to particles weight was added). Measurements in water were performed in presence of 1 mM HCl. D10, D50 and D90 values are given for volume distributions.

### Measurement of Solids Content

The solids content of powders and dispersions was determined using Mettler-Toledo HR-73 halogen moisture analyzer at 100° C.

### XRD Measurements

Powder samples were loaded on to a special flat plate Silicon sample holder, taking special care on producing a flat and smooth surface with the correct alignment to the sample holder zero-reference to avoid large systematic errors. The silicon sample holder was manufactured such that the it does not produce sharp diffraction features but only a weak and smooth background.

The sample on the sample holder was loaded in to a Panalytical 'XPert3 Powder equipped with a sealed Cu tube producing a characteristic X-ray lines Cu K_{α} and Cu K_{β} with wavelengths λ₁=1.54056 Å (Cu K_{α1}), λ₂=1.54439 Å (Cu K_{α2}), I₂/I₁=0.5 and λ₂=1.3922 Å (Cu K_{β}). The contribution of the latter (Cu K_{β}) was removed introducing a Ni-filter on the incident beam of the diffractometer right after the Cu-tube.

Diffraction data was collected from 10 to 80°2θ, using a step of 0.026°2θ for a total time of 2 h and spinning the sample around its axis at a rate of 0.13 rate/s in order to increase the sampling statistic.

The analysis of the diffraction patterns in terms of crystallographic phase analysis and average domain size was performed using the Panalytical HighScore software (v 4.8+) and the Bruker Topas6 program, obtaining consistent results.

The volume weighted domain size of diffraction (Dv) was evaluated using the Schemer equation (B. E. Warren, X-Ray Diffraction, Addison-Wesley Publishing Co., 1969) Dv=K λ/[β cos(θ)], where K(˜1) is the shape factor, dependent on the shape and reciprocal space direction, A the wavelength, β the integral breadth of the diffraction peak and θ the scattering half-angle. To ensure a correct determination of the Dv, the integral breadth β was amended of the instrumental contribution. To achieve this, the line-broadening of the powder reference material LaB₆ was measured and evaluated according to the same procedure, as described above.

### Example 1

### Step 1. Synthesis of TiO₂ Nanoparticles

Di(propyleneglycol) dimethyl ether (400 g) was placed in a 1 L double-wall reactor, equipped with a mechanical stirrer and a distillation head with a Liebig condenser. 2-Methyl-2-butanol (282.1 g) was added, followed by addition of tetraethyl orthotitanate (273.8 g), and the mixture was stirred for 5 min. Titanium tetrachloride (75.9 g) was added dropwise with stirring and the reaction mixture was heated to 120° C., during which time distillation has begun. The reaction mixture was stirred at 120° C. internal temperature (with jacket temperature control) for 24 h, upon which time distillate (440 g) was collected and the beige precipitate has formed. After that, the reaction temperature was increased to 150° C. and the stirring was continued for 5 h at this temperature.

The reaction mixture was cooled to 25° C., iso-propanol (400 g) was added and stirring was continued for 1 h. The mixture was filtered under vacuum through a paper filter (20 μm pore size), the product was washed on the filter with iso-propanol (500 g) and dried on the filter for 10 min after washing was complete. The beige powder (285.7 g) was obtained, which was resuspended in iso-propanol (550 g) in a 1 L 3-neck round-bottom flask, equipped with a magnetic stirring bar. This suspension was stirred for 2 h at 50° C. and then filtered under vacuum through a paper filter (20 μm pore size). The beige wet powder of TiO₂ nanoparticles agglomerates was obtained (294.4 g). Solids content at 100° C. 66.5% w/w. XRD analysis showed anatase to be the predominant phase with crystalline domain size of 2.7±1 nm. D10(v)=2.3 nm, D50(v)=3.3 nm, D90(v)=5.2 nm (in 1 mM HCl in water).

### Step 2. Neutralization/Re-Dispersion of TiO₂ Nanoparticles

The powder, obtained in Step 1 (290 g), was resuspended in absolute ethanol (400 g), the temperature of the mixture was raised to 50° C. and the pH of the mixture was brought to 4 via dropwise addition of 24% w/w potassium ethylate solution in absolute ethanol with stirring. Upon addition of potassium ethylate solution the turbidity of the mixture was strongly reduced due to the re-dispersion of TiO₂ nanoparticles agglomerates. The mixture was centrifuged at 3000 G for 30 min to remove the formed potassium chloride along with the traces of non-re-dispersed TiO₂ nanoparticles and the brown supernatant, containing redispersed TiO₂ nanoparticles, was collected (755 g). Solids content at 100° C. 22% w/w. D10(v)=2.0 nm, D50(v)=3.0 nm, D90(v)=5.3 nm (in presence of acrylic acid in ethanol).

### Step 3. Formulation of TiO₂ Nanoparticles as a UV-Curable Ink.

To the dispersion of TiO₂ nanoparticles, obtained in Step 2 (25 g), dipropyleneglycol diacrylate (0.825 g) was added and the mixture was concentrated on rotary evaporator to the total solids content (including acrylate) of 50% w/w. Photoinitiator Irgacure 819 (25 mg) was added. The obtained dispersion was diluted with 1-methoxy-2-propanol to the total solids content of 25% to obtain a UV-curable ink.

### Example 2

### Step 1. Synthesis of TiO₂ Nanoparticles

All operations were carried out under dry nitrogen atmosphere. Di(propylene glycol) dimethyl ether (400 g) was placed in a 1 L double-wall reactor, equipped with a mechanical stirrer and a distillation head with a Liebig condenser. 2,5-Dimethyl-2,5-hexanediol (234 g) was added, followed by addition of tetraethyl orthotitanate (273.8 g). The mixture was heated to 65° C. over 30 min with stirring and was kept for 15 min at this temperature. Titanium tetrachloride (75.9 g) was added dropwise with stirring and the reaction mixture was heated to 130° C. over 2 h, during which time distillation has begun. The reaction mixture was stirred at 125-130° C. internal temperature (with constant jacket temperature) for 3 h, upon which time distillate was collected and the beige precipitate has formed. After that, the internal reaction temperature was increased to 150° C. over 2 h and stirring was continued for 5 h at this temperature. In total, 315 g distillate was collected.

The reaction mixture was cooled to 77° C., absolute ethanol (200 g) was added and stirring was continued for 5 h at 77° C. The mixture was cooled to 25° C., isopropanol (300 g) was added, the mixture was stirred for 30 min at 25° C. and filtered under vacuum through a paper filter (20 μm pore size). The product was washed on the filter with iso-propanol (1000 g) and absolute ethanol (300 g) and dried on the filter for 1 min. The beige powder of TiO₂ nanoparticles agglomerates was obtained (247 g). Solids content at 100° C. 61.7% w/w. XRD analysis showed anatase to be the predominant phase with crystalline domain size of 3.1±0.3 nm. D₁₀(v)=2.1 nm, D₅₀(v)=3.0 nm, D₉₀(v)=4.8 nm (in 1 mM HCl in water).

### Step 2. Neutralization/Re-Dispersion of TiO₂ Nanoparticles

The powder, obtained in Step 1 (227 g), was resuspended in absolute ethanol (450 g). The temperature of the mixture was raised to 75° C., acetylacetone (5.6 g) was added and the pH of the mixture was brought to 4.5 via dropwise addition of 24% w/w potassium ethylate solution in absolute ethanol (98.6 g) with stirring at 75° C. Upon addition of potassium ethylate solution the turbidity of the mixture was strongly reduced due to the re-dispersion of TiO₂ nanoparticles agglomerates. The mixture was cooled to 25° C. and filtered through the depth filter sheet (Seitz® KS 50) under 2.5 Bar pressure to remove the formed potassium chloride along with the traces of non-re-dispersed TiO₂ nanoparticles. The brownish filtrate, containing re-dispersed TiO₂ nanoparticles, was collected (730 g). Solids content at 100° C. 18.1% w/w. D₁₀(v)=2.0 nm, D₅₀(v)=2.8 nm, D₉₀(v)=4.2 nm (in presence of acrylic acid in ethanol).

### Application Example 1

a) Preparation of Thin Films with High Refractive Index

The TiO₂ nanoparticles dispersion, obtained in Step 2 of Example 1, was diluted with absolute ethanol to the concentration of 5% w/w of solids. This dispersion was spin-coated onto a silicon wafer and dried at 100° C. for 1 min to obtain a 200 nm thick layer with a refractive index of 1.96 at 589 nm wavelength.

b) Preparation of UV-Cured Films with High Refractive Index.

The ink, obtained in Step 3 of Example 1, was spin-coated onto a silicon wafer, dried at 100° C. for 1 minute and the dry coating was cured using a medium pressure gallium-doped mercury UV lamp to obtain a 290 nm thick cured coating with a refractive index of 1.87 at 589 nm wavelength.

### Comparative Example 1 (p-Xylene as Non-Ethereal Solvent)

### Step 1. Synthesis of TiO₂ Nanoparticles

p-Xylene (150 g) was placed in a 0.5 L double-wall reactor, equipped with a mechanical stirrer and a distillation head with a Liebig condenser. 2-Methyl-2-butanol (70.5 g) was added, followed by addition of tetraethyl orthotitanate (68.4 g), and the mixture was stirred for 5 minutes. Titanium tetrachloride (19.0 g) was added dropwise with stirring and the reaction mixture was heated to 120° C., during which time distillation has begun. The reaction mixture was stirred at 120° C. internal temperature (with jacket temperature control) for 24 h, upon which time distillate (105 g) was collected and the white precipitate has formed. After that, the reaction temperature was increased to 135° C. and the stirring was continued for 5 h at this temperature.

The reaction mixture was cooled to 25° C., iso-propanol (100 g) was added and stirring was continued for 1 h. The mixture was filtered under vacuum through a paper filter (20 μm pore size), the product was washed on the filter with iso-propanol (150 g) and dried on the filter for 10 min after washing was complete. The beige powder (116 g) was obtained, which was resuspended in iso-propanol (150 g) in a 0.5 L 3-neck round-bottom flask, equipped with a magnetic stirring bar. This suspension was stirred for 2 h at 50° C. and then filtered under vacuum through a paper filter (20 μm pore size). The beige wet powder of TiO₂ nanoparticles agglomerates was obtained (119 g). Solids content at 100° C. 41.4% w/w.

### Step 2. Neutralization/Re-Dispersion of TiO₂ Nanoparticles

The wet filter cake, obtained in Step 1 (112 g), was resuspended in absolute ethanol (105 g), the temperature of the mixture raised to 50° C. and the pH of the mixture was brought to 4 via dropwise addition of 24% w/w potassium ethylate solution in absolute ethanol (26.9 g) with stirring. Upon addition of potassium ethylate solution no significant re-dispersion of TiO₂ nanoparticles agglomerates occurred.

### Comparative Example 2 (a Secondary Alcohol which does not Eliminate Water Upon Heating the Mixture to a Temperature of Above 60° C.)

Dipropylenglycol dimethylether (100 g) was placed in a 0.5 L double-wall reactor, equipped with a mechanical stirrer and a distillation head with a Liebig condenser. 2-Methylcyclohexanol (91.3 g) was added, followed by addition of tetraethyl orthotitanate (68.4 g), and the mixture was stirred for 5 min. Titanium tetrachloride (19.0 g) was added dropwise with stirring and the reaction mixture was heated to 120° C., during which time distillation has begun. The reaction mixture was stirred at 120° C. internal temperature (with jacket temperature control) for 72 h, upon which time distillate (35 g) was collected but no precipitate has formed. After that, the reaction temperature was increased to 130° C. and the stirring was continued for 24 h at this temperature. No precipitate of TiO₂ nanoparticles was formed.

### Comparative Example 3 (pH of Nanoparticles Dispersion According to Example 2 of WO19016136A1)

The transparent foamy material, obtained in Example 2 of WO19016136A1, was dissolved in water at 5% w/w concentration and pH was measured with ph meter. pH<1 was found.

1.-15. (canceled)

16. Process for the preparation of single, or mixed metal oxide nanoparticles comprising the following steps:
a) preparing a mixture, comprising a metal oxide precursor compound(s), a solvent, a tertiary alcohol, or a secondary alcohol, wherein the tertiary alcohol and secondary alcohol eliminate water upon heating the mixture to a temperature of above 60° C., or mixtures, containing the tertiary alcohol(s) and/or the secondary alcohol(s) and optionally water,
b) heating the mixture to a temperature of above 60° C.,
c) treating the obtained nanoparticles with a base, especially a base which is selected from the group consisting of alkali metal alkoxides, alkali metal hydroxides, alkali metal salts of carboxylic acids, tetraalkylammonium hydroxides, trialkylbenzylammonium hydroxides and combinations thereof, wherein
the metal oxide precursor compound(s) is selected from the group consisting of metal alkoxides of formula Me(OR¹²)ₓ (I), metal halides of formula Me′(Hal)_{x′} (II) and metal alkoxyhalides of formula Me″(Hal′)ₘ(OR^{12′})ₙ(III) and mixtures thereof, wherein
Me, Me′ and Me″ are independently of each other titanium, tin, tantalum, niobium, hafnium, or zirconium;
x represents the valence of the metal and is either 4 or 5,
x′ represents the valence of the metal and is either 4 or 5;
R¹² and R^{12′} are independently of each other a C₁-C₈alkyl group;
Hal and Hal′ are independently of each other Cl, Br or I;
m is an integer of 1 to 4;
n is an integer of 1 to 4;
m+n represents the valence of the metal and is either 4 or 5;
the solvent comprises at least one ether group and is different from the tertiary alcohol and the secondary alcohol;
the ratio of the sum of moles of hydroxy groups of tertiary alcohol(s) and secondary alcohol(s) to total moles of Me, Me′ and Me″ is in the range 1:2 to 6:1.

17. The process according to claim 16, wherein the tertiary alcohol is selected from the group consisting of tert-butanol, 2-methyl-2-butanol, 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 1-vinylcyclohexanol, 2-methyl-2,4-pentanediol, 2,4-dimethyl-2,4-pentanediol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 1-adamantanol, 2-methyl-3-buten-2-ol and 1-methoxy-2-methyl-2-propanol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), 3,7-dimethylocta-1,5-dien-3,7-diol (terpenediol I), terpinen-4-ol (4-carvomenthenol), (±)-3,7-dimethyl-1,6-octadien-3-ol (linalool) and mixtures thereof.

18. The process according to claim 16, wherein the solvent is selected from the group consisting of tetrahydrofuran, 2-methyltetrahydrofurane, tetrahydropyrane, 1,4-dioxane, cyclopen-tylmethyl ether, diisopropyl ether, di-n-propyl ether, di-isobutyl ether, di-tert-butyl ether, di-n-butyl ether, di(3-methylbutyl) ether (diisoamyl ether), di-n-pentyl ether, di-n-hexyl ether, di-n-octyl ether, ethylene glycol dimethyl ether, ethylene glycol di-ethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene glycol) di-n-butyl ether, 1,2-dimethoxypropane, 1,2-diethoxypropane, 1,3-dimethoxypropane, 1,3-diethoxypropane, 1,4-dimethoxybutane, 1,4-diethoxybutane, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof.

19. The process according to claim 16, wherein the mixture in step a) comprises a metal alkoxide of formula (I) and a metal halide of formula (II).

20. The process according to claim 16, wherein Me, Me′ and/or Me″ are titanium.

21. The process according to claim 16, wherein the temperature in step b) is in the range 80 to 180° C.

22. The process according to claim 16, comprising the following steps:
a) preparing a mixture, comprising a metal alkoxide of formula Ti(OR¹²)₄ (Ia), metal halide of formula Ti(Hal)₄ (IIa), wherein R¹² and R^{12′} are independently of each other C₁-C₄alkyl;
Hal is Cl; a solvent, a tertiary alcohol and optionally water,
b) heating the mixture to a temperature of from 80° C. to 180° C.,
c) treating the obtained nanoparticles with a base, wherein
the ratio of moles of hydroxy groups of tertiary alcohol to total moles of Ti is in the range 1:2 to 6:1;
the base is selected from the group consisting of alkali metal alkoxides, especially potassium ethylate; alkali metal hydroxides, especially potassium hydroxide; alkali metal salts of carboxylic acids, especially potassium acrylate and methacrylate and combinations thereof,
the solvent is selected from 2-methyltetrahydrofurane, tetrahydropyrane, 1,4-dioxane, cyclopentylmethyl ether, di-n-propyl ether, di-isobutyl ether, di-tert-butyl ether, di-n-butyl ether, ethylene glycol dimethyl ether, ethylene glycol diethyl ether, ethylene glycol di-n-propyl ether, ethylene glycol di-n-butyl ether, di(ethylene glycol) dimethyl ether, di(ethylene glycol) diethyl ether, di(ethylene glycol) di-n-propyl ether, di(ethylene gly-col) di-n-butyl ether, di(propylene glycol) dimethyl ether, di(propylene glycol) diethyl ether, tri(propylene glycol) dimethyl ether, tri(propylene glycol) diethyl ether, tri(ethylene glycol) dimethyl ether, tri(ethylene glycol) diethyl ether, tetra(ethylene glycol) dimethyl ether and tetra(ethylene glycol) diethyl ether and mixtures thereof;
the tertiary alcohol is selected from tert-butanol, 2-methyl-2-butanol, 3-methyl-3-pentanol, 3-ethyl-3-pentanol, 2-methyl-2-pentanol, 2,3-dimethyl-2-butanol, 1-methylcyclopentanol, 1-ethylcyclopentanol, 1-methylcyclohexanol, 1-ethylcyclohexanol, 2,3-dimethyl-2,3-butanediol, 2,5-dimethyl-2,5-hexanediol, 2,6-dimethyl-2-heptanol, 3,5-dimethyl-3-heptanol, 3,6-dimethyl-3-heptanol, 2-methyl-3-buten-2-ol, 2-phenyl-2-propanol, 2-phenyl-2-butanol, 3-phenyl-3-pentanol, 2-methyl-1-phenyl-2-propanol, α-, β-, γ- or δ-terpineol, 4-(2-hydroxyisopropyl)-1-methylcyclohexanol (p-menthane-1,8-diol), terpinen-4-ol (4-carvomenthenol), and wherein in step b) the alcohol R¹²OH is removed by distillation.

23. Metal oxide nanoparticles, obtainable according to the process of claim 16, especially titanium dioxide nanoparticles having a volume average particle size from 1 nm to 40 nm, and a film of the metal oxide nanoparticles, especially titanium dioxide nanoparticles which is dried at 100° C. for 1 minute shows a refractive index of greater than 1.70 (589 nm), especially of greater than 1.80, very especially of greater than 1.90 and dispersions of the metal oxide nanoparticles, especially the titanium dioxide nanoparticles in ethanol mixed with water (1:1 v/v) under vigorous stirring show a pH of higher than 3.5 and lower than 10.

24. Surface functionalized metal oxide nanoparticles, comprising the metal oxide nanoparticles of claim 23 treated with
a) a phosphonate of formula 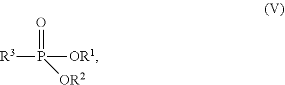
or a mixture of phosphonates of formula (V), wherein
R¹ and R² are independently of each other hydrogen, or a C₁-C₄alkyl group,
R³ is a group CH₂═CH—, or a group of formula —[CH₂]ₙ₂—R⁴, wherein
N2 is an integer of 1 to 12,
when n>3 one —CH₂— may be replaced by —S— with the proviso that S is not directly linked to P, or R⁴,
R⁴ is hydrogen, or a group of formula 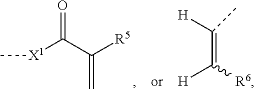
R⁵ is hydrogen, or a C₁-C₄alkyl group,
R⁶ is hydrogen, or a C₁-C₄alkyl group,
X¹ is O, or NH, and
b) bonded with an alkoxide of formula R⁷O⁻ (VI) and/or 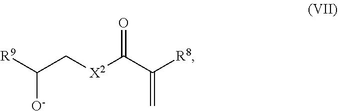
wherein
R⁷ is a C₁-C₈alkyl group, which may be interrupted one or more times by —O— and/or substituted one or more times by —OH,
R⁸ is hydrogen, or a C₁-C₄alkyl group,
R⁹ is hydrogen, —CH₂OH, —CH₂SPh, —CH₂OPh, or a group of formula R¹⁰—[CH₂OH—O—CH₂]ₙ₁—,
n1 is an integer of 1 to 5,
X² is O, or NH,
R¹⁰ is a group of formula —CH₂—X³—CH₂—C(═O)—CR¹¹═CH₂,
X³ is O, or NH, and
R¹¹ hydrogen, or a C₁-C₄alkyl group.

25. A coating, or printing composition, comprising the metal oxide nanoparticles according to claim 23, or the metal oxide nanoparticles obtained according to the process of claim 16, or the surface functionalized metal oxide nanoparticles according to claim 24 and optionally a solvent.

26. A security, or decorative element, comprising a substrate, which may contain indicia or other visible features in or on its surface, and on at least part of the said substrate surface, a coating, comprising the metal oxide nanoparticles according to claim 23, or the metal oxide nanoparticles obtained according to the process of claim 16, or the surface functionalized metal oxide nanoparticles according to claim 24.

27. A method for forming a surface relief micro- and nanostructure on a substrate comprising the steps of:
a) forming a surface relief micro- and nanostructure on a discrete portion of the substrate; and
b) depositing the coating, or printing composition according to claim 25, on at least a portion of the surface relief micro- and nanostructure; or
a method for forming a surface relief micro- and/or nanostructure on a substrate comprising the steps of
a′) providing a sheet of base material, said sheet having an upper and lower surface;
b′) depositing the coating composition according to claim 25 on at least a portion of the upper surface; and
c′) forming a surface relief micro- and/or nanostructure on at least a portion of the coating composition, and
d′) curing the coating composition by exposing it to actinic radiation, especially, UV-light; or
a method for forming a surface relief micro- and/or nanostructure on a substrate, comprising the steps of
a″) providing a sheet of base material, said sheet having an upper and lower surface;
b″) depositing the coating composition according to claim 25 on at least a portion of the upper surface; and
c″) optionally removing a solvent;
d″) curing the dry coating by exposing it to actinic radiation, especially UV-light; and
e″) forming a surface relief micro- and/or nanostructure on at least a portion of the coating composition.

28. The method according to claim 27, wherein step a) comprises
a1) applying a curable compound to at least a portion of the substrate;
a2) contacting at least a portion of the curable compound with surface relief micro- and nanostructure forming means; and
a3) curing the curable compound.

29. Use of the coating, or printing composition according to claim 25 for coating holograms, manufacturing of optical waveguides and solar panels.

30. Use of the metal oxide nanoparticles according to claim 23, or the metal oxide nanoparticles obtained according to the process of claim 16, or the surface functionalized metal oxide nanoparticles according to claim 24 in light outcoupling layers for display and lighting devices, high dielectric constant (high-k) gate oxides and interlayer high-k dielectrics, anti-reflection coatings, etch and CMP stop layers, protection and sealing (OLED), organic solar cells, optical thin film filters, optical diffractive gratings and hybrid thin film diffractive grating structures, or high refractive index abrasion-resistant coatings.
